(19) United States
(12) Patent Application Publication
(10) Pub. No.: US 2002/0174029 A1
(43) Pub. Date: Nov. 21, 2002

(54) Method for collecting semiconductor devices and method for selling and using semiconductor devices

(75) Inventor: Shigenobu Maeda, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, TOKYO (JP)

(21) Appl. No.: 09/970,701

(22) Filed: Oct. 5, 2001

(30) Foreign Application Priority Data
May 17, 2001 (JP) 2001-147684

(51) Int. Cl. G06F 17/60

(52) U.S. Cl. 705/26

(57) ABSTRACT

A method for collecting semiconductor devices and a method for selling and using semiconductor devices in consideration of collection are provided. When a user of an electrical appliance containing a semiconductor chip discards the electrical appliance, the user disassembles the electrical appliance and removes the semiconductor chip from the printed board on which it is mounted (S1). The user can thus obtain a service number provided on the back (S2) and in step S3 reports the service number to the manufacturer of the electrical appliance, or the manufacturer of the semiconductor chip, or a service organization acting for the purpose of collection. When receiving the report, the manufacturer or the service organization gives a reward to the user (S4) and separately collects the semiconductor chip (S5).

### BACKGROUND OF THE INVENTION

1. Field of the Invention

The present invention relates to a method for collecting semiconductor devices and a method for selling and using semiconductor devices.

2. Description of the Background Art

Semiconductor devices are indispensable components in present-day society; most household electrical appliances contain semiconductor devices. Although some of the electrical appliances are collected and recycled, most of them are discarded as industrial waste after use. However, semiconductor devices may contain heavy metals as their essential elements, such as As (arsenic), or semiconductor chips may be attached to the printed boards with solder containing Pb (lead). Carelessly discarding semiconductor devices may therefore cause environmental problems.

The reasons the semiconductor devices are thus disposed of after use include the keen price competition. That is to say, under current conditions, prices of semiconductor devices change so rapidly that consideration cannot be given to collection during manufacture and sales.

Semiconductor devices, having become essential components, will remain indispensable in the foreseeable future, and it will therefore be necessary to establish a public service system for recycling them.

### SUMMARY OF THE INVENTION

A first aspect of the present invention is directed to a semiconductor device collecting method for separately collecting a packaged semiconductor device provided on a printed board. According to the first aspect, the method comprises the steps of: (a) previously providing predetermined information on a package surface of the semiconductor device which faces the printed board; (b) dismounting the semiconductor device from the printed board so that the semiconductor device can be separately collected and so that the predetermined information can be seen, and receiving a report based on the predetermined information from the user; and (c) collecting the separated semiconductor device.

Preferably, according to a second aspect, in the semiconductor device collecting method, the step (a) comprises a step of providing a service number as the predetermined information on the package surface facing the printed board, and the step (b) comprises a step of giving a reward for the separate collection to the user who reported the service number.

Preferably, according to a third aspect, in the semiconductor device collecting method, the step (b) comprises a step of accepting the report about the service number through a communication network.

Preferably, according to a fourth aspect, in the semiconductor device collecting method, the step (a) comprises a step of sticking a label as the predetermined information on the package surface facing the printed board, and the step (b) comprises a step of giving a reward for the separate collection to the user who sent the label.

A fifth aspect is directed to a method for selling and using a semiconductor device contained in an electrical appliance, comprising the steps of: (a) selling the electrical appliance to a user in a condition in which the electrical appliance cannot operate without input of predetermined data; and (b) remotely supplying the predetermined data to the user through a communication network to enable the input to the electrical appliance.

Preferably, according to a sixth aspect, in the semiconductor device selling and using method, the predetermined data comprises code data for approving operation of the electrical appliance.

Preferably, according to a seventh aspect, in the semiconductor device selling and using method, the predetermined data comprises software for a microcomputer which controls operation of the electrical appliance.

Preferably, according to an eighth aspect, in the semiconductor device selling and using method, the step (a) comprises a step of selling the electrical appliance at a predetermined discount determined by considering the price of the semiconductor device, and the step (b) comprises a step (b-1) of, through the communication network, and in exchange for a right to use the semiconductor device, making an agreement about a fee which the user pays to use the semiconductor device and setting the fee which the user pays to use the semiconductor device.

Preferably, according to a ninth aspect, in the semiconductor device selling and using method, the step (b-1) comprises a step of setting the fee for the use of the semiconductor device on the basis of the frequency of use of the electrical appliance.

Preferably, according to a tenth aspect, in the semiconductor device selling and using method, the frequency of use of the electrical appliance is calculated on the basis of the amount of power consumed by the semiconductor device.

Preferably, according to an eleventh aspect, in the semiconductor device selling and using method, the frequency of use of the electrical appliance is calculated on the basis of the amount of data processed by the semiconductor device.

Preferably, according to a twelfth aspect, in the semiconductor device selling and using method, the amount of data processed by the semiconductor device is calculated by comparing, in time to a clock signal, present data inputted to the semiconductor device and previous data preceding the present data by one clock, and incrementing a counter for counting the number of clocks of the clock signal when the present data and the previous data disagree and calculating the amount of data on the basis of the total number counted.

According to the semiconductor device collecting method of the first aspect of the invention, the semiconductor device is removed from the printed board and the user sends a report on the basis of the predetermined information. This facilitates separate collection of the semiconductor device and promotes environmental preservation through collection of Pb and As and the recycling of rare resources through collection of noble metals such as Au and Pt.

According to the semiconductor device collecting method of the second aspect, the user is given a reward when he/she removed the semiconductor device from the printed board and reported the service number. This further facilitates the separate collection of the semiconductor device. The user is required just to report the service number provided on the package surface of the removed semiconductor device which faces the printed board, which is not much trouble for the user.

According to the semiconductor device collecting method of the third aspect, the user reports the service number through a communication network, so that the information can be processed easily to smoothly and quickly proceed with the procedures for giving reward and collecting the semiconductor device.

According to the semiconductor device collecting method of the fourth aspect, the user is given a reward when he/she removed the semiconductor device from the printed board and sent the label. This further promotes the separate collection of the semiconductor device. Furthermore, the user is unlikely to make an incorrect report since he/she just sends the label attached on the dismounted semiconductor device.

According to the semiconductor device selling and using method of the fifth aspect, predetermined data is remotely supplied to the user through a communication network. For example, a fee can be collected for the supply of the predetermined data and the semiconductor manufacturer can pool the money as the costs for collecting semiconductor devices. Then the semiconductor manufacturer can steadily obtain the costs of collection and promote the recycling of the semiconductor devices.

According to the semiconductor device selling and using method of the sixth aspect, code data for approving operation of the electrical appliance is used as the predetermined data. The code data can be expressed with a small amount of data.

According to the semiconductor device selling and using method of the seventh aspect, software for the microcomputer which controls operation of the electrical appliance is used as the predetermined data, which prevents dishonest use since it is difficult to counterfeit.

According to the semiconductor device selling and using method of the eighth aspect, the fee which the user pays to use the semiconductor device contained in the electrical appliance is settled in exchange for the right to use the semiconductor device. Accordingly, for example, the semiconductor manufacturer can periodically obtain the fee for use and pool the money as the costs for collecting the semiconductor device. The semiconductor manufacturer can thus steadily obtain the cost of collection and promote the recycling of the semiconductor device. The user can buy the electrical appliance at a predetermined discount determined considering the price of the semiconductor device, without a feeling of loss. Furthermore, an agreement about the fee for the use of the semiconductor device and the setting of the fee for the use of the semiconductor device are made through a communication network, so that the information can be processed easily to quickly proceed with the procedure.

According to the semiconductor device selling and using method of the ninth aspect, the fee to use the semiconductor device is set on the basis of how often the electrical appliance is used. This prevents unfair payment of the user's fees even when the frequencies of use vary.

According to the semiconductor device selling and using method of the tenth aspect, the frequency of use of the electrical appliance is calculated on the basis of the amount of power consumed by the semiconductor device. This enables precise calculation of the fee for the use of the semiconductor device.

According to the semiconductor device selling and using method of the eleventh aspect, the frequency of use of the electrical appliance is calculated on the basis of the amount of data processed by the semiconductor device. This enables more precise calculation of the fee for the use of the semiconductor device.

The semiconductor device selling and using method of the twelfth aspect provides a simple and practical method for calculating the amount of data processed by the semiconductor device.

The present invention has been made to solve the problem mentioned above, and an object of the present invention is to provide a method for realizing collection of semiconductor devices and a method for selling and using semiconductor devices while taking the collection into account.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the structure of a semiconductor device for realizing a semiconductor device collecting method according to a first preferred embodiment of the present invention;

FIG. 2 is a flowchart showing the semiconductor device collecting method of the first preferred embodiment of the present invention;

FIG. 3 is a diagram showing the structure of a semiconductor device for realizing a variation of the semiconductor device collecting method of the first preferred embodiment of the present invention;

FIG. 4 is a flowchart showing the variation of the semiconductor device collecting method of the first preferred embodiment of the present invention;

FIG. 5 is a flowchart showing a variation of the semiconductor device collecting method of the first preferred embodiment of the present invention;

FIG. 6 is a block diagram showing a semiconductor device selling and using method according to a second preferred embodiment of the present invention;

FIG. 7 is a block diagram showing a variation of the semiconductor device selling and using method of the second preferred embodiment of the present invention;

FIGS. 8 and 9 are block diagrams used to describe a semiconductor device selling and using method according to a third preferred embodiment of the present invention;

FIG. 10 is a flowchart showing the semiconductor device selling and using method of the third preferred embodiment of the present invention;

FIG. 11 is a diagram showing the structure of a current measuring means for measuring current flowing in a single semiconductor chip;

FIG. 12 is a diagram showing a structure for measuring current flowing in a plurality of semiconductor chips;

FIG. 13 is a diagram showing the structure of a data amount calculating means for calculating the amount of data processed by a semiconductor chip; and

FIG. 14 is a timing chart showing the operation of the data amount calculating means.

### DESCRIPTION OF THE PREFERRED EMBODIMENTS

<A. First Preferred Embodiment>

<A-1. System Structure and Operation>

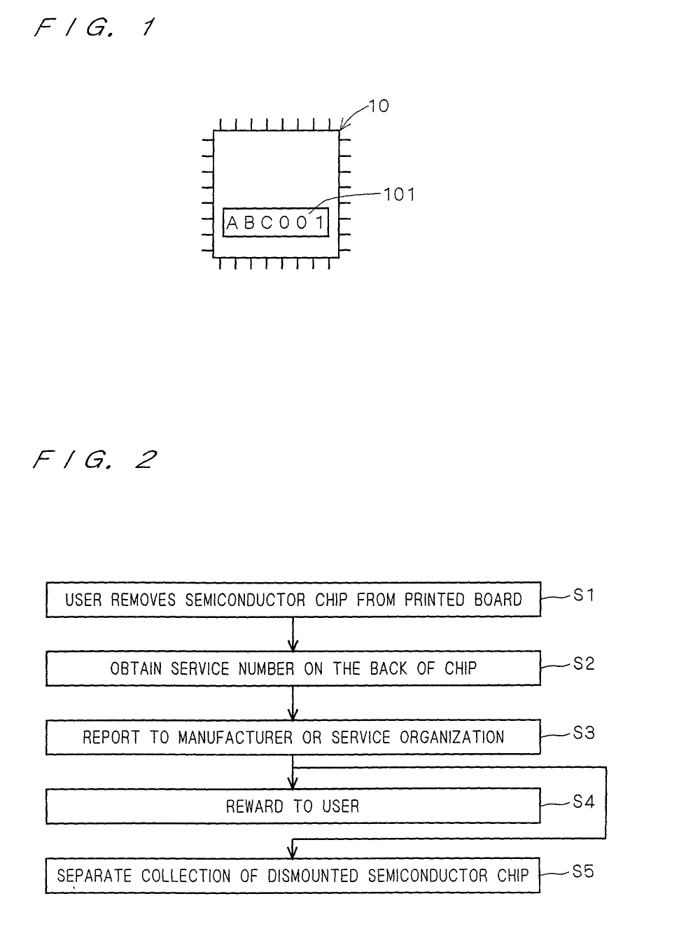

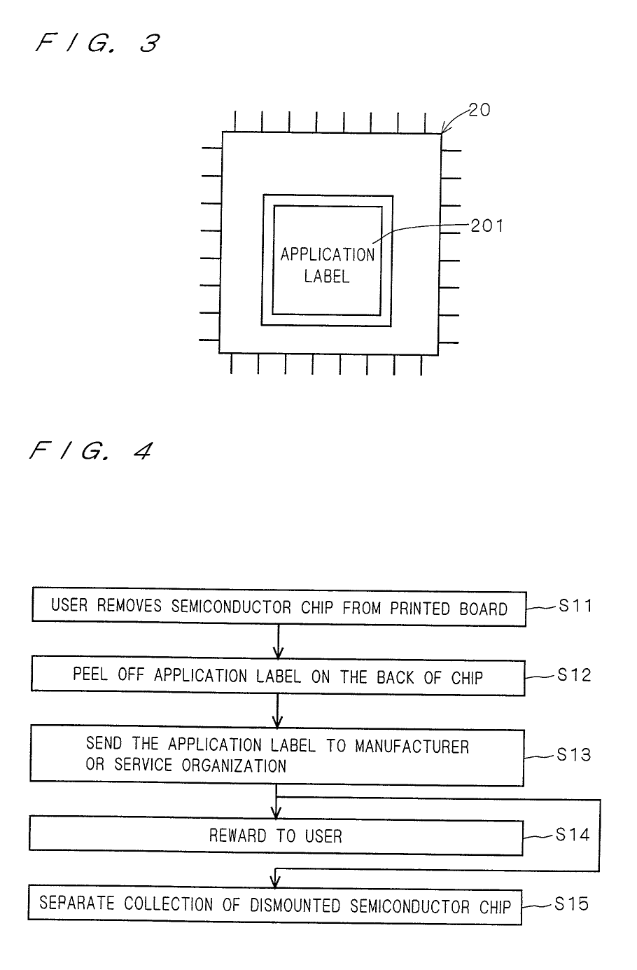

A semiconductor device collecting method according to a first preferred embodiment of the present invention is now described referring to FIGS. 1 and 2.

FIG. 1 is a plan view showing the back of a semiconductor chip 10 in which a semiconductor device is packaged; the semiconductor chip 10 is mounted on a printed board. A predetermined number (referred to as service number hereinafter) 101, used for the purpose of collection, is printed on the back of the semiconductor chip 10. The service number 101 cannot be read when the semiconductor chip 10 is mounted on the printed board, since they are joined together with the back side of the semiconductor chip 10 facing the surface of the printed board.

This service number 101 brings a profit to the user through the procedure shown in FIG. 2.

That is to say, in step S1 of FIG. 2, when the user of the electrical appliance containing the semiconductor chip 10 discards the electrical appliance, the user disassembles the electrical appliance and removes the semiconductor chip 10 from the printed board on which it is mounted.

The user can thus obtain the service number 101 printed on the back (step S2). The service number 01 contains information about the manufacturer, type, etc. of the semiconductor chip.

Next, in step S3, the user reports the service number 01 to the manufacturer of the electrical appliance, or the manufacturer of the semiconductor chip, or a service organization acting for the purpose of collecting semiconductor devices. While the report may be sent through the Internet, telephone, or facsimile, reporting through the Internet will be advantageous because the user can send the report anytime and also because the manufacturer or service organization can easily process the information. This will facilitate procedures for giving a reward and collecting the semiconductor device and enable quick reply.

While the Internet was mentioned above, any network using the Internet Protocol (IP) can be used as well as the Internet. This applies also to the wording “Internet” in the second and third preferred embodiments shown later. A network using a protocol other than the Internet Protocol can be used, too.

When receiving the report, the manufacturer or service organization rewards the user for the report (step S4). This reward may be cash or an article, or may be a right to receive some service. The reward may be given to all users who sent reports, or to part of the users chosen by lottery.

The manufacturer or service organization, who received the report, sends a collector or informs the user of how to send the semiconductor chip 10, so as to separately collect the semiconductor chip 10 (step S5).

Through this series of steps, the manufacturer or service organization can collect the semiconductor chip 10 and the user can receive the reward.

As for the service organization for collection, manufacturers of semiconductors and manufacturers of electrical appliances may tie up together or cooperate with the government to establish an organization; preferably, semiconductor manufacturers all over the world join in to establish a world-wide organization. This lessens users' trouble because they can send reports collectively to the service organization independently of the manufacturer of the semiconductor chip contained in the electrical appliance.

Needless to say, only Japanese semiconductor manufacturers may cooperate to establish an organization, or only Asian semiconductor manufacturers may cooperate to establish one.

The costs required to give rewards to users are previously included in the price of the semiconductor chip 10 and paid back to the users. The costs required to recycle the collected semiconductor chips 10 are also incorporated in the price.

<A-2. Functions and Effects>

According to the above-described semiconductor device collecting method of the first preferred embodiment, the user removes the semiconductor chip 10 from the printed board to obtain the service number 101. The semiconductor ship 10 can thus be separately collected with ease, promoting environmental preservation through collection of Pb and As and also promoting the recycling of rare resources through collection of noble metals such as Au (gold) and Pt (platinum).

<A-3. First Variation>

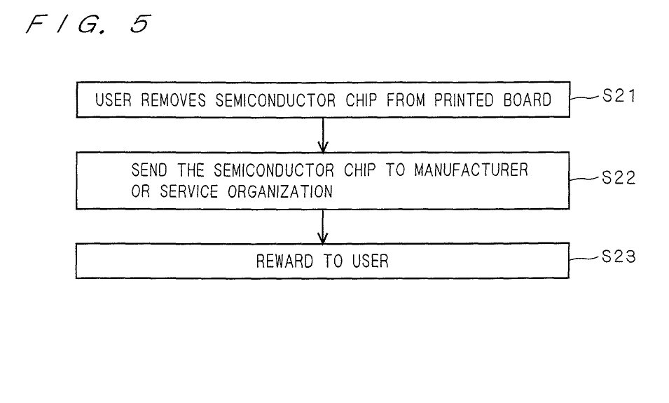

While the semiconductor device collecting method of the first preferred embodiment adopts the method in which the service number 101 printed on the back of the semiconductor chip 10 is reported, the method shown in FIGS. 3 and 4 may be adopted.

FIG. 3 is a plan view showing the back of a semiconductor chip 20. A label 201 used for the purpose of application is affixed on the back of the semiconductor chip 20. The application label 201 cannot be peeled off with the semiconductor chip 20 mounted.

This application label 201 brings a profit to the user through the procedure shown in FIG. 4. Different manufacturers may use different application labels 201, or they may use a common label.

That is to say, first, in step S11 shown in FIG. 4, when the user of the electrical appliance containing the semiconductor chip 20 discards the electrical appliance, the user disassembles it and removes the semiconductor chip 20 from the printed board on which it is mounted.

The user can then peel off the application label 201 from the back (step S12).

Next, in step S13, the user sends the application label 201 to the manufacturer of the electrical appliance, or the manufacturer of the semiconductor chip, or a service organization working for collection. As for means of sending, a sheet on which the application label 201 can be stuck, e.g. a postcard, is attached to the written guarantee or manual of the electrical appliance so that the user can put the application label 201 on it and post it. Needless to say, the user may prepare a postcard etc. by himself.

When receiving the application label 201 thus sent, the manufacturer or service organization gives a reward to the user (step S14). This reward is offered as described in the first preferred embodiment.

Also, in order to collect the semiconductor chip 20, the manufacturer or service organization who received the report sends a collector or informs the user of how to send the semiconductor chip 20, so as to collect the semiconductor chip 20 separately (step S15).

The user thus sends the application label 201 and receives a reward. It is thus possible to shorten the time required for report even when the discarded electrical appliance contains many semiconductor chips.

<A-4. Second Variation>

While the user cannot earn the reward unless he/she removes the semiconductor chip from the printed board both in the first preferred embodiment and the first variation, the method shown in FIG. 5 may be adopted.

That is to say, first, in step S21 shown in FIG. 5, when the user discards the electrical appliance, the user disassembles it and removes the semiconductor chip from the printed board on which it is mounted.

Next, in step S22, the user sends the dismounted semiconductor chip to the manufacturer of the electrical appliance, or the manufacturer of the semiconductor chip, or the service organization for collection. The cost required for sending is paid by the manufacturer or the service organization.

When receiving the semiconductor chip thus sent, the manufacturer or service organization gives a reward to the user (step S23). This reward is offered as described in the first preferred embodiment.

The manufacturer or service organization can thus directly receive the dismounted semiconductor chip, which reduces the cost of the collection, leading to an increased amount of reward to the user.

When the user can hand in the dismounted semiconductor chip at a retail store dealing with the electric appliance and receive a reward there, the user can dispose of it more easily without the need to package the semiconductor chip to send it.

In order to realize the collecting method of the first preferred embodiment and its variations, it is desirable to design the electrical appliance so that the user can easily remove the printed board, and also to promote the spread of tools for removing the semiconductor chip (e.g. nippers for cutting external leads of the semiconductor chip). This may require the users to take some trouble. However, since the separate collection of wastes is now being loudly promoted from the environmental preservation viewpoint, it is not impossible to appeal to the users to be fully aware of recycling. The collecting methods described above will certainly be accepted by society.

<B. Second Preferred Embodiment>

It is said in the semiconductor device collecting method of the first preferred embodiment and its variations that the costs of collection are included in the price of the semiconductor chip. However, in order to fully promote the spread of the collection of semiconductor devices in the future, it is necessary to establish a new method for selling and using the semiconductor devices while considering the costs of collection.

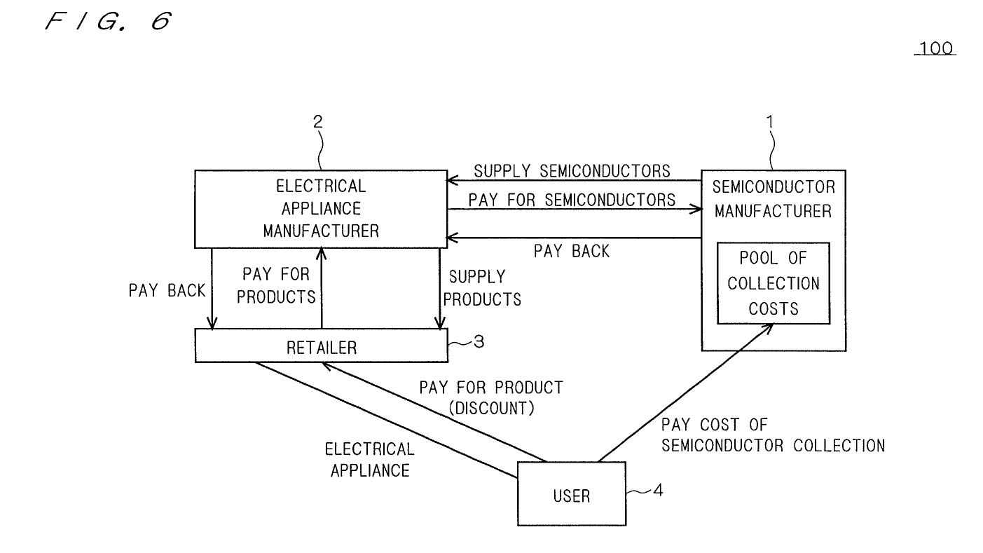

A method for selling and using semiconductor devices of a second preferred embodiment of the present invention is now described referring to FIG. 6.

<B-1. System Structure and Operation>

FIG. 6 is a block diagram showing a method 100 for selling and using semiconductor devices considering how to earn the costs of collection of the semiconductor devices.

In FIG. 6, the manufacturer of semiconductor chips (semiconductor manufacturer) 1 supplies the manufacturer of electrical appliances, 2, with various types of semiconductor devices, such as semiconductor chips. The electrical appliance manufacturer 2 then pays for the semiconductor devices to the semiconductor manufacturer 1.

Then the electrical appliance manufacturer 2 supplies the retailer 3 with electrical appliances they manufactured and receives payment for the products from the retailer 3.

When a user 4 buys an electrical appliance from the retailer 3 and pays for it, the user 4 can obtain a predetermined discount off the price of the electrical appliance, the discount determined considering the price of the semiconductor device.

For example, when the price of the semiconductor device makes up ten percent of the manufacturing cost of the electrical appliance, the user can buy it at a price determined by subtracting a certain percentage of the price of the semiconductor device from the retail price of the electrical appliance.

This is possible because in this system the semiconductor manufacturer 1 and the user 4 makes a contract about the collection of the semiconductor device (particularly the semiconductor chip).

That is to say, as shown in FIG. 6, the user who is buying the electrical appliance at the discount makes a contract with the semiconductor manufacturer 1 to pay the cost of collection of the semiconductor device by the month, for example.

The semiconductor device manufacturer 1 pools, and may invest, the money periodically paid by the contract as funds for collection and appropriates the money for the costs of collection of the semiconductor devices.

The costs of collection include the amount corresponding to the discount to the user 4, and the amount corresponding to the discount to the user 4 is paid back to the electrical appliance manufacturer 2 from the pooled collecting funds.

The electrical appliance manufacturer 2 pays it back further to the retailer 3, thus compensating for the discount to the user 4.

Administering the pooled collection funds may bring profits, which will then enable reduction of the amount the user 4 periodically pays. Then the sum total the user periodically pays can be smaller than the price of the semiconductor device, which will cause the user 4 to feel that he/she got a good bargain.

The electrical appliance manufacturer 2 may do business directly with the user 4 without through the retailer 3, in which case the retailer 3 is removed from the system shown in FIG. 6.

<B-2. Functions and Effects>

According to the above-described method 100 for selling and using semiconductor devices, the semiconductor manufacturer 1 pools the money periodically paid from the user 4 for the sake of collection; the semiconductor manufacturer 1 can thus steadily obtain the costs of collection and promote the recycling of the semiconductor devices.

The collecting method described in the first preferred embodiment and its variations can be used as a specific system for collecting the semiconductor devices.

<B-3. First Variation>

In the semiconductor device selling and using method 100, the user can buy the electrical appliance at a price determined by subtracting a certain percentage of the price of the semiconductor device from the retail price of the electrical appliance. When this system is further advanced, the electrical appliance can be sold at a price determined by subtracting the price of the semiconductor device from the retail price of the electric appliance.

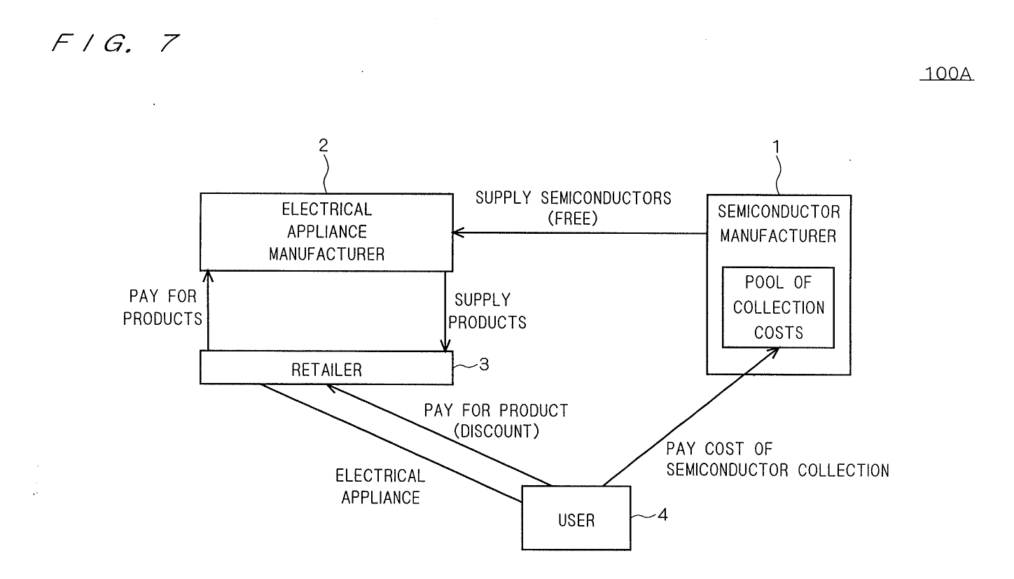

FIG. 7 shows a semiconductor device selling and using method 100A as a first variation of this preferred embodiment.

In FIG. 7, the semiconductor manufacturer 1, the electrical appliance manufacturer 2, the retailer 3, and the user 4 are related to each other in basically the same way as those shown in the semiconductor device selling and using method 100 shown in FIG. 6. However, the semiconductor manufacturer 1 supplies the electrical appliance manufacturer 2 with semiconductor devices (particularly semiconductor chips) for free. Then the electrical appliance manufacturer 2 supplies manufactured products to the retailer 3 at a discount corresponding to the price of the semiconductor devices and receive from the retailer 3 the payment for the products (excluding the price of the semiconductor devices).

When the user 4 buys an electrical appliance from the retailer 3 and pays for it, the user 4 can buy it at a retail price determined by subtracting the price of the semiconductor device from the price of the electrical appliance.

This is possible for the reason described in the semiconductor device selling and using method 100. However, in this case, the user 4 periodically pays a larger amount of money than in the semiconductor device selling and using method 100, on the basis of a contract settled for collection of the semiconductor devices between the semiconductor manufacturer 1 and the user 4.

That is to say, in the semiconductor device selling and using method 100A, when the discount to the user 4 is set equal to the price of the semiconductor device and the sum total the user 4 pays to the semiconductor manufacturer 1 is set equal to the price of the semiconductor device, it is equivalent to direct dealing of the semiconductor device between the semiconductor manufacturer 1 and the user 4.

This can be regarded as periodically receiving the value of the semiconductor device, rather than as receiving the costs of collection, and the semiconductor manufacturer 1 can therefore freely decide at its discretion how to use the money obtained by selling the semiconductor devices, as long as the manufacturer certainly use part of the money to collect the semiconductor devices.

An enormous amount of collection funds will be pooled and the semiconductor manufacturer 1 can thus obtain steady income. The semiconductor manufacturer 1 can use the money as working funds to secure their business, which will enable steady supply of semiconductor devices, resulting in reduction of the prices of the semiconductor devices and hence profits to the user 4.

While the semiconductor device selling and using methods 100 and 100A have shown examples in which the user 4 makes a contract about collection of the semiconductor device directly with the semiconductor manufacturer 1, the electrical appliance often contains semiconductor devices manufactured by a plurality of semiconductor manufacturers. This requires the user 4 to make contracts with individual semiconductor manufacturers, which is too troublesome for the user and not realistic.

In this case, as shown in the first preferred embodiment of the invention, the burdens of the user can be lessened when semiconductor manufacturers and electrical appliance manufacturers cooperate to establish a service organization for the purpose of collecting the semiconductor devices, so that the user can effect a contract with all semiconductor manufacturers by making a contract with the service organization.

The service organization for collection is required to grasp what semiconductor devices (especially semiconductor chips) are contained in electrical appliances bought by users and to assign the money paid from the users to the individual semiconductor manufacturers. This is not impossible when manufacturers of the electrical appliances are taking part in the operation.

Even if electrical appliance manufacturers do not participate in the operation, this system can be achieved by requiring them by law to disclose what semiconductor devices are used in the electrical appliances they produce.

Instituting such law or rules is not impossible, in view of the recent tendencies toward the recycling of resources and environmental preservation.

<B-4. Second Variation>

When it is assumed that the types of semiconductor devices contained in electrical appliances are disclosed, the costs for collecting the semiconductor devices can be raised by a still simpler system.

That is to say, on the basis of the types and number of chips contained in each electrical appliance, the cost required to collect the semiconductor chips in the electrical appliance is previously determined for each appliance, and the cost is included in the price of the electrical appliance.

When the user discards the electrical appliance, the user hands over the useless appliance to a professional scrap collector and receives a predetermined amount of money from the previously included collection cost. This lessens the trouble of the user and ensures collection of the semiconductor chips.

<C. Third Preferred Embodiment>

<C-1. System Structure>

In the semiconductor device selling and using method of the second preferred embodiment and its variations, the user periodically pays the cost for collecting the semiconductor devices. However, the user may fail to carry out the contract and then the cost of collection cannot be collected.

This problem can be solved by establishing a system in which the contract is periodically renewed between the user and the semiconductor manufacturer.

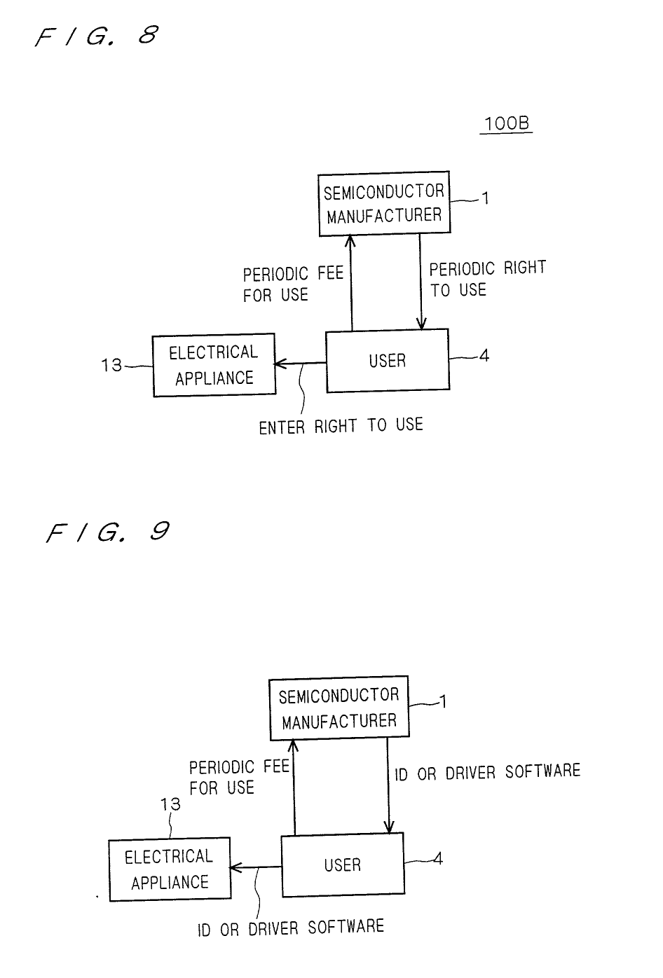

A semiconductor device selling and using method 100B according to a third preferred embodiment is now described referring to FIG. 8.

FIG. 8 illustrates the user 4 and the semiconductor manufacturer 1 shown in the semiconductor device selling and using methods 100 and 100A described referring to FIGS. 6 and 7. This diagram does not show the electrical appliance manufacturer 2 and the retailer 3 since they are related as shown in FIGS. 6 and 7.

As shown in FIG. 8, according to the contract between the semiconductor manufacturer 1 and the user 4, the user 4 periodically pays a fee for the use of the semiconductor device to periodically buy the right to use the semiconductor device from the semiconductor manufacturer 1. The electrical appliance 13 the user 4 bought is constructed so that it does not work unless the right to use, bought from the semiconductor manufacturer 1, is periodically entered into it. The semiconductor manufacturer 1 can thus certainly obtain the costs for collecting the semiconductor devices in terms of fees for use.

The right to use can be set differently in each time so as to prevent dishonest use.

The intervals at which the right to use is renewed can be arbitrarily chosen between the semiconductor manufacturer 1 and the user 4; for example, the contract can be made on a six-month or annual basis with an electrical appliance constantly used throughout a year (e.g. refrigerators etc.), or on a weekly basis with an electrical appliance used for only several days per month. The right to use can thus be set according to how often the electrical appliance is used, so as to avoid unfair payments.

The fee for setting the right to use depends on whether this system is applied to the semiconductor device selling and using method 100 or 100A described referring to FIGS. 6 and 7. The fee is set relatively low when it is applied to the semiconductor device selling and using method 100 and relatively high when applied to the semiconductor device selling and using method 100A.

The electrical appliance 13 may be handed over to someone as a used article. In this case, measures are taken by altering the contract with the semiconductor manufacturer 1 or by setting a long-term right to use before handing it over.

The right to use does not necessarily have to be set throughout the life of the electrical appliance 13, but can be settled flexibly; for example, the user may be exempted from setting the right to use when five years have passed after the purchase and the total sum paid for the right to use has exceeded a predetermined amount. This makes it easier to hand over the electrical appliance 13 as a secondhand article.

The new user who obtained the secondhand article can obtain a profit by dismounting the semiconductor chip according to the semiconductor device collecting method described in the first preferred embodiment.

While the description above has used the term “right to use,” what the semiconductor manufacturer 1 actually delivers to the user 4 as data required to enable the electrical appliance 13 to operate is an identification code for use (hereinafter called ID) or driver software for actually enabling operation, for example.

The driver software for enabling operation of the electrical appliance 13 is a program which causes the microcomputer, controlling the electrical appliance, to operate, and the identification code is code data which is given to the microcomputer to cause it to operate.

Using driver software as the data required for operation of the electrical appliance 13 prevents dishonest use since it is difficult to counterfeit. An advantage of using ID is that it can be expressed with a small amount of data.

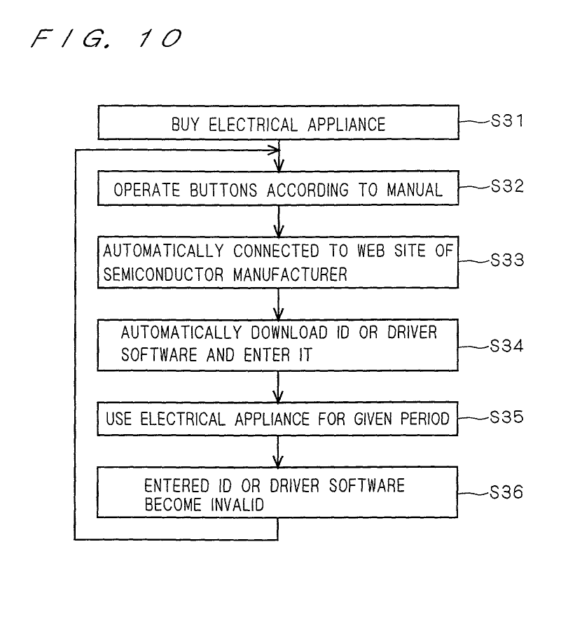

Its more specific structure is now described referring to FIGS. 9 and 10.

FIG. 9 is a block diagram showing a practical structure of the semiconductor device selling and using method 100B described referring to FIG. 8.

As shown in FIG. 9, according to a contract between the semiconductor manufacturer 1 and the user 4, the user 4 periodically pays a fee for the use of the semiconductor device to periodically buy from the semiconductor manufacturer 1 an ID or driver software for operating the electrical appliance 13, or the right to use. The user can use the electrical appliance 13 by entering the ID or driver software into the electrical appliance 13.

Next, referring to the flowchart of FIG. 10, the procedure for entering the ID or driver software is now described.

First, the user buys the electrical appliance 13. At this time, as described in the second preferred embodiment, the user can obtain a discount determined by considering the price of the semiconductor device (step S31). The electrical appliance 13 has a function of making a connection to a LAN (Local Area Network) or a network using the Internet Protocol, for example. The subsequent steps are described on the assumption that it is connected to a network.

Next, in step S32, the user operates buttons on the electrical appliance 13 according to the manual.

The electrical appliance 13 is thus automatically connected to the Web site of the semiconductor manufacturer 1 through the network (step S33).

The user then settles at what intervals he/she will renew the contract and how to pay the fee for use and then the ID or driver software is automatically downloaded (step S34).

Then the user can freely use the electrical appliance 13 (step S35). However, when the period determined in the contract has passed, the entered ID or driver software becomes invalid, and the user performs the operation of and after step S32 again to renew the contract.

At present, studies are being made to provide electrical appliances with the function of making a connection to a network; IPv6 (Internet Protocol Version 6) offers 128-bit address space. It is thus possible to add IP addresses to all electrical appliances used at home.

Connection to the network can be made not only through telephone network but also through power line or cable television (CATV). When the electrical appliance 13 is constructed so that it can be connected to a network terminal through wireless communication, the electrical appliance 13 can be freely located or moved without the need for a communication line.

<C-2. Functions and Effects>

In this way, adopting a system in which the user 4 periodically buys the right to use prevents the user from violating the contract and ensures payment of the costs for collecting the semiconductor devices.

The semiconductor device selling and using method 100B has shown an example in which the user 4 receives an ID or driver software for the use of the electrical appliance 13 directly from the semiconductor manufacturer 1. However, the electrical appliance often uses semiconductor devices produced by a plurality of semiconductor manufacturers. Therefore the ID or driver software, for operating not a single semiconductor device but the entire electrical appliance, will usually be produced by the manufacturer of the electrical appliance.

Accordingly, as shown in the first preferred embodiment of the invention, when manufacturers of semiconductors and electrical appliances, for example, cooperate to establish a service organization for the purpose of collecting semiconductor devices, the service organization can mediate the electronic appliance manufacturers and the semiconductor manufacturers, so that the user 4 can easily obtain the ID or driver software by settling a contract with the service organization.

<C-3. Variations>

The semiconductor device selling and using method of the third preferred embodiment and its variation have shown a system in which the user settles a contract with the semiconductor manufacturer to use the semiconductor device and the contract is renewed at predetermined intervals. However, this system may result in unfair payments of fees for use, depending on how often the electrical appliances are used, i.e. depending on the frequency of use.

A system in which the fee for use is determined on the basis of the frequency of use will be effective to solve this problem. Structures for calculating the frequency of use of the semiconductor chip are now described.

### C-3-1. FIRST EXAMPLE

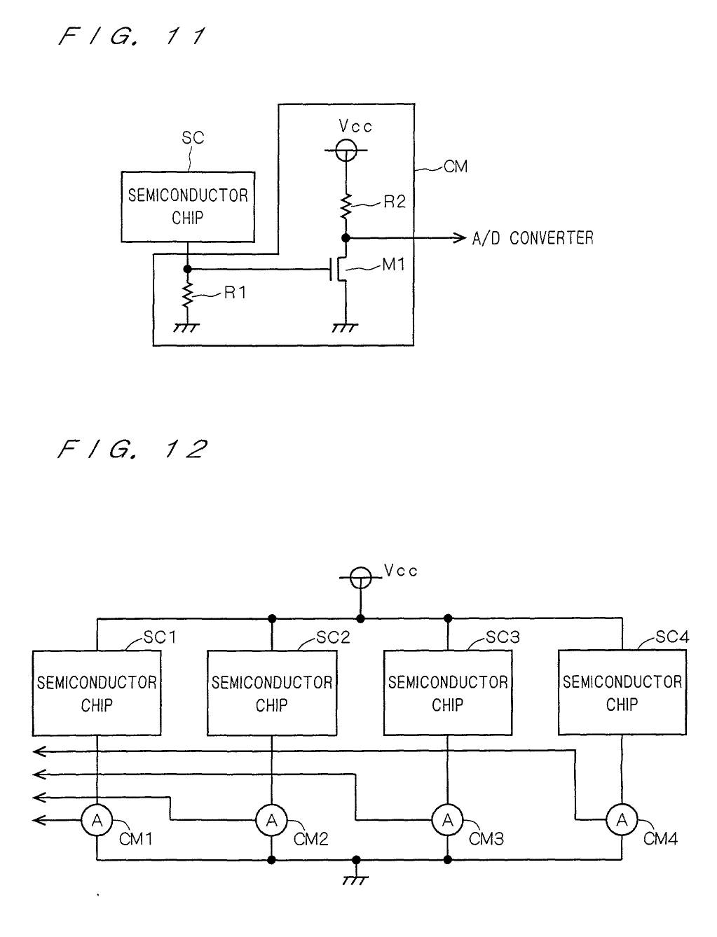

FIG. 11 shows the structure of a current measuring means CM for measuring current flowing in the semiconductor chip.

In FIG. 11, the semiconductor chip SC has a common ground which is grounded through a resistor R1 having small resistance. The resistor R1 has its one end, on the side of the semiconductor chip SC, connected to the gate electrode of an MOS transistor M1.

The MOS transistor M1 is connected to power-supply potential Vcc through a resistor R2, and the main electrode of the MOS transistor M1 on the side of the resistor R2 is connected to an A/D converter.

When the semiconductor chip SC operates, a current flows through the resistor R1 and a potential difference is produced across both ends of the resistor R1. The resistance value of the resistor R1 is set low to suppress consumption of current and a low voltage is applied to the gate electrode of the MOS transistor M1.

The threshold of the MOS transistor M1 is also set low, close to 0 V. When the MOS transistor M1 turns on, a voltage corresponding to the current flowing in the semiconductor chip SC is applied to the A/D converter. As a result, the current flowing in the semiconductor chip SC can be read from the output of the A/D converter, and the total power consumed in the semiconductor chip can be obtained by measuring the time for which the current flows.

This structure for measuring current is provided in the electrical appliance 13 and the total power consumption is automatically reported to the semiconductor manufacturer 1 at the time when the contract is renewed. This enables fair payment of the user's fee.

Since an electrical appliance contains a plurality of semiconductor chips, the above-described current measuring structure is provided in each semiconductor chip so as to measure current consumed in each semiconductor chip. Thus, even if the semiconductor chips are produced by different semiconductor manufacturers, the fees for use can be paid to the respective semiconductor manufacturers according to the power consumption. FIG. 12 shows a structure for achieving this.

FIG. 12 shows an example using semiconductor chips SC1 to SC4 and current measuring means CM1 to CM4 connected to the respective chips. Each of the current measuring means CM1 to CM4 corresponds to the current measuring means CM shown in FIG. 11. The circuit shown in FIG. 11 is the simplest example; circuitry with other structure can be used as long as it can realize the function of measuring current flowing in the semiconductor chip.

### C-3-2. SECOND EXAMPLE

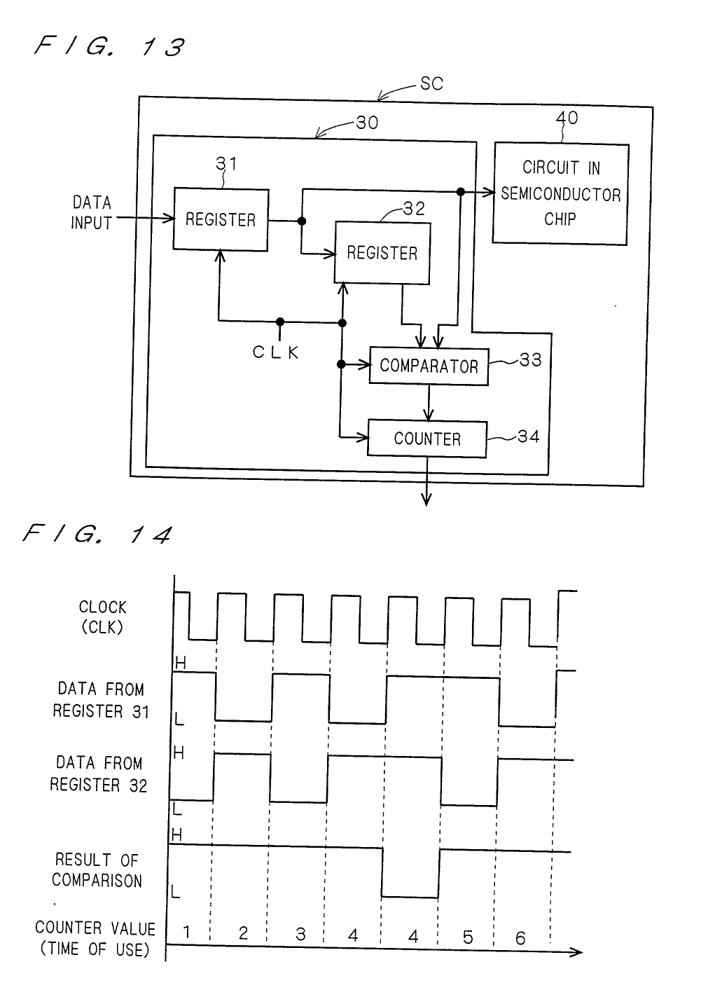

FIG. 13 shows the structure of a data amount calculating means 30 for calculating the frequency of use from the amount of signal (data) processed by the semiconductor chip.

As shown in FIG. 13, the data amount calculating means 30, provided in the semiconductor chip SC, comprises a register 31 receiving data input to the semiconductor chip SC, a register 32 receiving the output of the register 31, a comparator 33 for comparing the output of the register 32 and the output of the register 31, and a counter 34 for counting the result of comparison made in the comparator 33.

The output of the register 31 is input to an in-chip circuit 40 and the register 32 in time to application of a clock signal CLK.

Next, the operation of the data amount calculating means 30 is described referring to FIG. 14. The register 32 holds data which precedes that in the register 31 by one clock and the comparator 33 compares the present data output from the register 31 and the one clock earlier data output from the register 32.

As shown in FIG. 14, the comparator 33 compares the data from the register 31 and the data from the register 32 in time to the clock signal CLK; when the two disagree, it outputs the result of comparison at “H,” and when the two agree, it outputs the result of comparison at “L.” When receiving the result at “H,” the counter 34 counts the clock signal and increments the count by one.

When the counter 34 receives the result at “L,” it does not count the clock signal and keeps the count unchanged. FIG. 14 shows an example in which the fifth clock signal is not counted.

The result of comparison at “L” shows that the data has remained unchanged between the present data and the data one clock earlier, meaning that the semiconductor chip SC is not operating. The total time for which the semiconductor chip SC operated can be known from the total number of clocks counted in the counter 34.

The fee for use can thus be set according to the frequency of use on the basis of the operating time, enabling fair payment of the fee.

While the data amount calculating means 30 is provided in each semiconductor chip, it causes no problem with the manufacture and structure of the semiconductor chips since its structure is very simple.

The frequency of use of the electrical appliance can be measured in the simplest way by measuring the time from when the electronic appliance is turned on to when it is turned off. That is to say, since using the semiconductor chip requires turning on power to the electrical appliance, the time from power-on to power-off can be used as an approximate time for which the semiconductor chip has been used.

The above-described third preferred embodiment and its variations were made on the assumption that the electrical appliance is connected to a network. Another advantage of this method is that the semiconductor device can be collected easily because it is known in this method where the last user of the semiconductor device is located, and where the semiconductor device is located.

The fact that the location of the last user is known also facilitates services such as repairs of troubles, upgrading (especially of the program), etc.

It is of course possible to adopt a system in which the fee for use is set on the basis of the frequency of use of the semiconductor chip until a predetermined amount of use is reached and the fee is fixed after that.

While the invention has been described in detail, the foregoing description is in all aspects illustrative and not restrictive. It is understood that numerous other modifications and variations can be devised without departing from the scope of the invention.

What is claimed is:

1. A semiconductor device collecting method for separately collecting a packaged semiconductor device provided on a printed board, comprising the steps of:
(a) previously providing predetermined information on a package surface of said semiconductor device which faces said printed board;
(b) dismounting said semiconductor device from said printed board so that said semiconductor device can be separately collected and so that said predetermined information can be seen, and receiving a report based on said predetermined information from the user; and
(c) collecting separated said semiconductor device.

2. The semiconductor device collecting method according to claim 1,
wherein said step (a) comprises a step of providing a service number as said predetermined information on the package surface facing said printed board, and
said step (b) comprises a step of giving a reward for the separate collection to said user who reported said service number.

3. The semiconductor device collecting method according to claim 2, wherein said step (b) comprises a step of accepting the report about said service number through a communication network.

4. The semiconductor device collecting method according to claim 1,
wherein said step (a) comprises a step of sticking a label as said predetermined information on the package surface facing said printed board, and
said step (b) comprises a step of giving a reward for the separate collection to said user who sent said label.

5. A method for selling and using a semiconductor device contained in an electrical appliance, comprising the steps of:
(a) selling said electrical appliance to a user in a condition in which said electrical appliance cannot operate without input of predetermined data; and
(b) remotely supplying said predetermined data to said user through a communication network to enable the input to said electrical appliance.

6. The semiconductor device selling and using method according to claim 5, wherein said predetermined data comprises code data for approving operation of said electrical appliance.

7. The semiconductor device selling and using method according to claim 5, wherein said predetermined data comprises software for a microcomputer which controls operation of said electrical appliance.

8. The semiconductor device selling and using method according to claim 5,
wherein said step (a) comprises a step of selling said electrical appliance at a predetermined discount determined by considering the price of said semiconductor device, and
said step (b) comprises a step (b-1) of, through said communication network, and in exchange for a right to use said semiconductor device, making an agreement about a fee which said user pays to use said semiconductor device and setting said fee which said user pays to use said semiconductor device.

9. The semiconductor device selling and using method according to claim 8, wherein said step (b-1) comprises a step of setting said fee for the use of said semiconductor device on the basis of the frequency of use of said electrical appliance.

10. The semiconductor device selling and using method according to claim 9, wherein said frequency of use of said electrical appliance is calculated on the basis of the amount of power consumed by said semiconductor device.

11. The semiconductor device selling and using method according to claim 9, wherein said frequency of use of said electrical appliance is calculated on the basis of the amount of data processed by said semiconductor device.

12. The semiconductor device selling and using method according to claim 11, wherein said amount of data processed by said semiconductor device is calculated by,
in time to a clock signal, comparing present data inputted to said semiconductor device and previous data preceding said present data by one clock, and
incrementing a counter for counting the number of clocks of said clock signal when said present data and said previous data disagree and calculating said amount of data on the basis of the total number counted.
